(19) United States
(12) Patent Application Publication
(10) Pub. No.: US 2017/0149379 A1
(43) Pub. Date: May 25, 2017

(54) INTERCONNECT DEVICE FOR USE IN ISLANDING A MICROGRID

(71) Applicant: Enphase Energy, Inc., Petaluma, CA (US)

(72) Inventors: Christopher N. Rowe, Old Bar (AU); Donald Richard Zimmanck, Petaluma, CA (US); Michael J. Harrison, Petaluma, CA (US); Martin Fornage, Petaluma, CA (US)

(21) Appl. No.: 15/357,340

(22) Filed: Nov. 21, 2016

Related U.S. Application Data
(60) Provisional application No. 62/258,032, filed on Nov. 20, 2015.

(51) Int. Cl. H02S 40/34; H02J 3/38; H02J 3/46; H01H 50/16; H02H 3/08; H01H 47/22; H01H 50/56; H02S 40/32; H02J 3/40

(52) U.S. Cl. CPC H02S 40/34; H02S 40/32; H02J 3/383; H02J 3/46; H02J 3/40; H02H 3/08; H01H 47/22; H01H 50/56; H01H 50/16; H02J 2003/388

(57) ABSTRACT

System and apparatus for electrically coupling a microgrid to and from a power distribution grid. In one embodiment, the apparatus comprises an interconnect device, coupled to the microgrid and the power distribution grid, comprising (i) an overcurrent protection component (OPC) for interrupting a circuit during an overcurrent condition; and (2) a contactor component, coupled in series with the OPC and independently operable from the OPC, comprising (a) a set of contacts movable between a first position and a second position; (b) a first coil energizable to move the set of contacts from the first position into the second position; and (c) a second coil energizable, independently of the first coil, to maintain the contacts in the second position after the first coil is de-energized until a level of current flowing through the set of contacts is less than a lower current level.

### CROSS-REFERENCE TO RELATED APPLICATION

This application claims benefit of U.S. Provisional Patent Application No. 62/258,032 filed Nov. 20, 2015, which is herein incorporated in its entirety by reference.

### BACKGROUND OF THE INVENTION

Field of the Invention

Embodiments of the present disclosure relate generally to electric control systems and more particularly to an interconnect device for connecting to and/or disconnecting from a power source.

Description of the Related Art

A microgrid having both a generating capability and a storage capability may be able to meet or exceed the demand from one or more load(s) drawing power from it for extended periods of time. However, the resources of the microgrid may not always be sufficient to meet the demand for power. At such times, it may be desirable for the microgrid to connect to an alternative power source such, for example, as a commercial power grid and, later, disconnect from that alternative power source.

Accordingly, there is a need in the art for a microgrid interconnect device capable of safely, reliably, and economically interconnecting a microgrid with an alternative power source.

### SUMMARY OF THE INVENTION

Embodiments of the present invention generally relate to a system and apparatus for electrically coupling a microgrid to and from a power distribution grid as shown in and/or described in connection with at least one of the figures.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a system for power distribution utilizing one or more microgrid interconnect device(s) according to embodiments of the present invention;

FIG. 2 is a block diagram of a microgrid interconnect device in accordance with one or more embodiments of the present invention;

FIG. 3 is a block diagram of a microgrid interconnect device in accordance with one or more split-phase embodiments of the present invention;

FIG. 4 is a block diagram of a microgrid interconnect device utilizing a transformer interconnection approach to energization of a line power receiving coil in accordance with one or more embodiments of the present invention; and

FIG. 5 is a block diagram of a microgrid interconnect device utilizing a current divider approach to energization of a line power receiving coil in accordance with one or more embodiments of the present invention.

### DETAILED DESCRIPTION

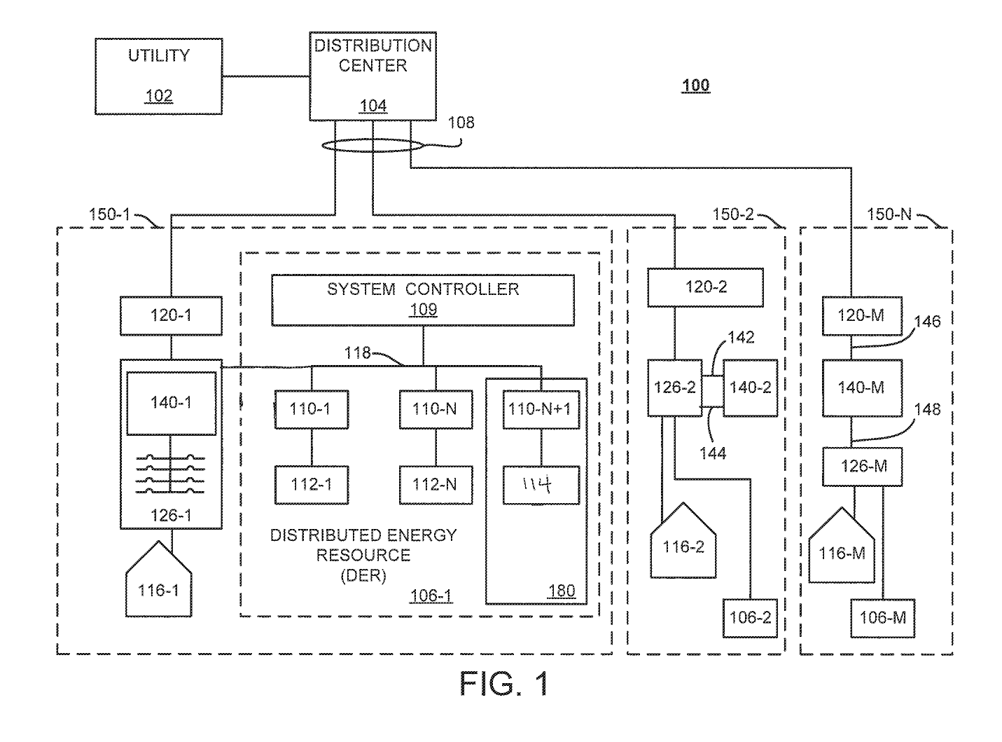

FIG. 1 is a block diagram of a system 100 for power distribution utilizing one or more microgrid interconnect device(s) according to embodiments of the present invention. This diagram only portrays one variation of the myriad of possible system configurations. The present invention can function in a variety of environments and systems.

The system 100 comprises a power grid comprising a utility 102 (such as a commercial power plant) coupled, by high-voltage transmission lines, to a distribution center 104. The distribution center 104 is coupled to a plurality of microgrids 150-1, 150-2 . . . 150-M (collectively referred to as microgrids 150) by respective power distribution lines 108, but may also be further coupled to other distribution centers (not shown) of utility 102 by additional distribution lines (not shown).

Each of microgrids 150-1 to 150-M may comprise one or more buildings (e.g., residences, commercial building, or the like). For clarity and ease of illustration, however, each of microgrids 150-1 to 150-M is depicted in FIG. 1 as comprising a single building. Each of the buildings, respectively identified at reference numerals 116-1 to 116-M, is coupled to a corresponding one of load centers 126-1 to 126-M. According to one or more embodiments, each of microgrids 150-1 to 150-M further includes a microgrid interconnect device (e.g., “MID” devices 140-1, 140-2 . . . 140-M, or collectively MID devices 140). Each load center 140 of a microgrid 150, such as load center 126-1 of microgrid 150-1, may be connected to/disconnected from the distribution center 104 by a corresponding MID device 140 as described herein. The MIDs 140-1 to 140-M themselves are coupled to the power distribution lines 108 (which may also be referred to as a power distribution grid) of distribution center 104 via corresponding utility meters 120-1 to 120-M (collectively referred to as utility meters 120).

In an embodiment, MID 140-1 has a form factor compatible with the internal construction of load center 126-1 of microgrid 150-1, enabling MID 140-1 to be installed within load center 126-1. Other MIDs 140, such as MIDs 140-2 and 140-M, may be configured for installation in separate enclosures, branched from or upstream of corresponding load centers 126-2 and 126-M, respectively, so as to accommodate retrofit installations. As an example of the former (i.e., branched) configuration, an MID 140-2 may be installed in a junction box and integrated into a pre-existing installation that already includes the load center 126-2 for distributing power to loads (not shown) associated with building 116-2. To this end, a first cable 142 may feed power from load center 126-2 to one or more line connection(s) of MID 140-2 and a second cable 144 may feed power from one or more load connection(s) of MID 140-2 to load center 126-2.

As an example of an upstream configuration, an MID 140-M may be installed in a junction box upstream of a pre-existing installation that already includes a load center 126-M for distributing power to loads (not shown) associated with building 116-M. To this end, a first cable 146 may feed power from meter 120-M to one or more line connection(s) of MID 140-M and a second cable 148 may feed power from one or more load connection(s) of MID 140-M to load center 126-M.

Each of the load centers 126-1 to 126-M is also coupled to a corresponding one of distributed energy resources (DERs) 106-1 to 106-M (collectively DERs 106) in order to couple power between the corresponding one of the buildings 116-1 to 116-M, the corresponding one of the DERs 106-1 to 106-M, and the distribution line 108. For example, load center 126-1 couples power between building 116-1, DER 106-1, and distribution center 104, allowing delivery of power to loads associated with the building 116-1, and so on.

In embodiments, each of DERs 106-1 to 106-M comprises a power conditioner (e.g., one of power conditioners 110-1 . . . 110-N, 110-N+1), where the number “N” may vary in value among the DERs 106-1 to 106-M within different microgrid branches 150. The power conditioners 110-1 to 110-N+1 are respectively coupled in parallel to a corresponding AC bus, as bus 118. Generally the power conditioners 110-1 to 110-N+1 are bi-directional power conditioners, where a first subset of the power conditioners 110-1 to 110-N+1 is coupled to a plurality of energy sources. The energy sources may be DC or AC energy sources (or a combination thereof) and include, for example, renewable energy sources such as wind, solar, hydro, and the like. A second subset of the power conditioners 110-1 to 110-N+1 is coupled to energy storage devices (e.g., batteries). A power conditioner and corresponding energy storage device may be referred to as an AC battery.

In the embodiment depicted in FIG. 1, the power conditioners 110-1 . . . 110-N are coupled to DC energy sources 112-1 . . . 112-N, respectively, for receiving DC power and generating commercial power grid compliant AC power that is coupled to the AC bus 118. As further depicted in FIG. 1, the power conditioner 110-N+1 is coupled to an energy storage device 114 to form AC battery 180. For the AC battery 180, the power conditioner 110-N+1 can convert power from the bus 118 to energy that is stored in the energy storage device 114, and can convert energy stored in the energy storage device 114 to commercial power grid compliant AC power that is coupled to the AC bus 118. In some embodiments, one or more power conditioners 110 may be coupled to an energy storage device such as a hot water heater, an electric car, or the like.

In one or more embodiments, each DC energy source 112-1 . . . 112-N is a photovoltaic (PV) module coupled to the corresponding power conditioner 110-1-110-N in a one-to-one correspondence; in certain embodiments, multiple DC sources 112 are coupled to a single power conditioner 110 (e.g., a single, centralized power conditioner). In some alternative embodiments, the power conditioners 110 are DC-DC power converters that generate DC power and couple the generated power to a DC bus and subsequent DC system; such DC-DC power converters also may receive power from the DC bus and convert the received power to energy that is then stored in an energy storage device. In some other alternative embodiments, the power conditioners 110 may be AC-AC converters that convert receive a first AC power and convert the received power to an AC output power.

A system controller 109 for the DER 106-1 is coupled to the AC bus 118 and communicates with the power conditioners 110 (e.g., via power line communications (PLC) and/or other types of wired and/or wireless techniques). The system controller 109 generally comprises a CPU coupled to each of a transceiver, support circuits, and a memory that stores the operating system (if necessary) as well as various forms of application software, such as a DER control module for controlling some operational aspects of the DER 106 and/or monitoring the DER 106 (e.g., issuing certain command and control instructions to one or more of the power conditioners 110, collecting data related to the performance of the power conditioners 110, and the like). The system controller 109 may send command and control signals to one or more of the power conditioners 110 and/or receive data (e.g., status information, data related to power conversion, and the like) from one or more of the power conditioners 110. In some embodiments, the system controller 109 is further coupled, by wireless and/or wired techniques, to a master controller via a communication network (e.g., the Internet) for communicating data to/receiving data from the master controller (e.g., system performance information and the like).

Although only the DER 106-1 is shown in detail in FIG. 1, the DERs 106-2 to 106-M are generally analogous to the DER 106-1 although the number of one or more of power conditioners 110, DC energy sources 112, and energy storage devices 114 may vary among the DERs 106.

When microgrid 150-1 is to be coupled to the distribution center 104, as when local capacity of microgrid 150-1 is insufficient for loads served by load center 126-1, an appropriate connection is made by MID 140-1. In some embodiments, control input for initiating an interconnection may be generated by and received by MID 140-1 from the local system controller (i.e., system controller 109) with which microgrid 150-1 is associated. In other embodiments, control input may be received from a master controller or other upstream controller (not shown), e.g., using an industrial networking technology such as Ethernet/Modbus. In still other embodiments, the MID 140-1 itself may include an integral controller (not shown) operative to receive sensory input (e.g., from line and/or load voltage and/or current sensing transducers). According to embodiments, while a connection is maintained by MID 140-1, current from distribution center 104 may flow through one or more sets of contacts rated to carry a continuous flow of current at the amp rating of a corresponding load center (e.g., 200 A) or other upper limit associated with one or more loads, which upper limit may be referred to as a first or upper current level.

In an embodiment, the contacts of MID 140-1 are normally open (i.e., the moveable elements of the contacts are in a first position such that they are not in contact with the fixed elements of the contacts) and closure is initiated (i.e., the movable elements are moved to a second position such that they are in contact with the fixed elements and a connection across the contacts is “made”) in response to application of an actuating control input. In embodiments, the control input may correspond to a call for coupling of microgrid 150-1 to distribution center 104. When the connection is to be broken, MID 140-1 receives further control input or, alternatively, application of the control input is terminated. However, according to one or more embodiments, at least some of the contacts of MID 140-1 are prevented from returning to the normally open position to break the connection until the power drawn by the loads coupled to load center 126-1 falls below a second current level which is lower than the first current level. In embodiments, the second current level, which may also be referred to as a lower current level, is no higher than the make and break rating of the contacts. Although the contacts of MID 140-1 are described as being normally open, in some alternative embodiments they are normally closed.

In embodiments, the second current level is equal to or less than the make and break rating of the contacts (i.e., the threshold at which the occurrence of arcing is expected to compromise the integrity and safe operation of the contacts before completion of a prescribed number of operating cycles). For example, in a conventional molded case circuit breaker designed to allow manual opening and closure, as well as to automatically open in the event of a short circuit or fault, arc extinguishers are provided to ameliorate the effects of arcing and avoid damage to the breaker contacts. Similar provisions may be made in a contactor designed to automatically open and close by energization (or de-energization) of an actuating coil.

In embodiments, MID 140-1 employs at least one pair of discrete, circuit interrupting components, each with a corresponding set of contacts. The first component (also referred to herein as an overcurrent protection component or OPC) and the second component (also referred to herein as a contactor component) are independently operable and/or controllable such that asymmetry is facilitated between the make/break rating of the first component and that of the second component.

In embodiments, the first component comprises a manual disconnect and a current overload protection device. In the event of an overload or fault condition, opening of the manual disconnect, or energization of a shunt trip coil (in circuit breaker implementations of the overload protection device), the supply of current to the second component and any load(s) coupled thereto is interrupted. The second component has a continuous rating which may be equal to that of the first component, and a make/break rating which may be substantially less than that of the first component. According to one or more embodiments, operation of the second component is controllable such that the contacts of the second component are not opened or closed until the current flowing through them falls to a non-deleterious level (e.g., below both the first current level and the second current level).

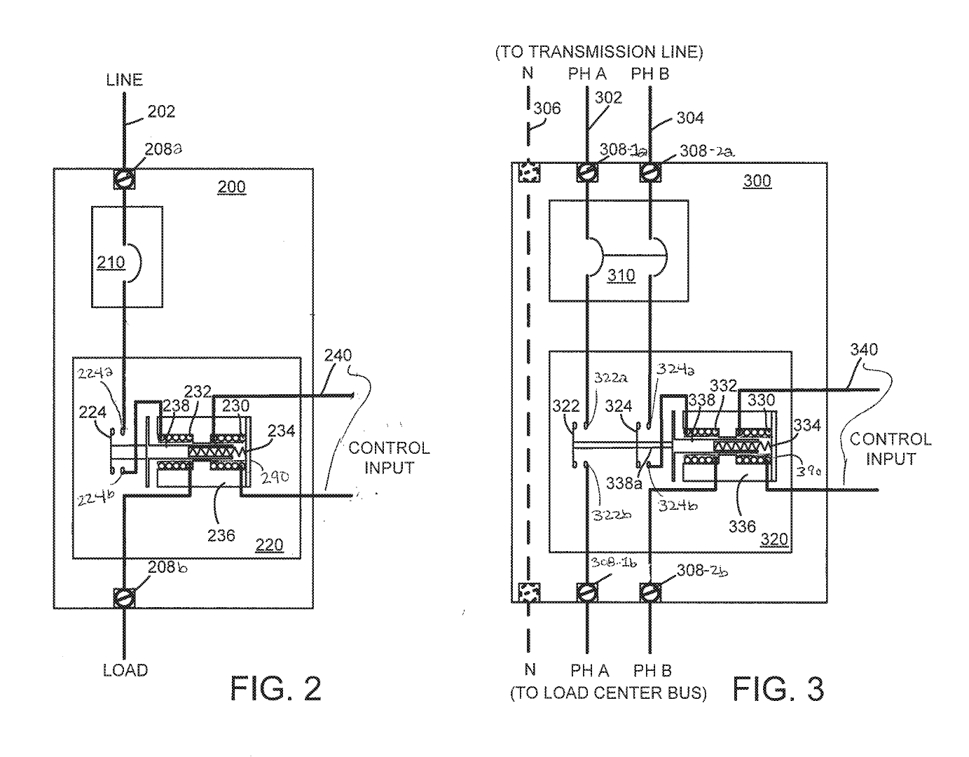

FIG. 2 is a block diagram of a microgrid interconnect device (MID) 200 in accordance with one or more embodiments of the present invention. The MID 200 is one embodiment of the MID 140. In an embodiment, MID 200 is a single phase implementation receiving alternating current (AC) power over line conductor 202. The conductor 202 is coupled, via a grid-side terminal connector 208a, to a normally open, overcurrent protection component (OPC) 210 of MID 200.

The OPC 210 may have the construction of a fused switch or that of a circuit breaker (as shown) such that it is capable of being manually opened or closed, as well as opened automatically (i.e., without user intervention) in the event of an overcurrent or fault condition.

Once closed, OPC 210 may supply power to a dual coil contactor component 220 which, in an embodiment, has a set of normally open contacts 224 which, when closed, are in contact with fixed contacts 224a and 224b (although in some alternative embodiments the normally open contacts 224 may be normally closed). The movable set of contacts 224 is carried by a movable core 238 within a stationary core 236. The stationary core 236 is a magnetic core substantially shaped as an “H” revolved around one of the vertical legs of the “H” and having the resulting vertical central cylinder hollowed out. A first end of the stationary core 236 is coupled flush to a circular magnetic base 290; in some embodiments, the base 290 may be part of the form factor of the stationary core 236. The movable core 238 is a substantially T-shaped magnetic core having the vertical bar of the “T” disposed through the hollow center of stationary core 236 with the end of the vertical bar of the “T” coupled to a first end of a spring 234 such that, when the spring 234 is in a first position (e.g., compressed), the horizontal bar of the “T” is flush with the second end of the stationary core 236 and the contacts 224 are closed. The second end of the spring 234 is coupled to the base 290 (or, alternatively, another fixed structure). A first coil 230 is wound around a first portion of the central cylinder of the core 236 with the ends of the winding coupled to electrodes 240 for receiving a control signal. In some embodiments, the first coil 230 may be coupled to the line voltage through a relay in series with the coupling, where the relay serves as an actuator that a controller can use to drive the device. For example, one of the electrodes 240 may be coupled to the line voltage at 224a while the other of the electrodes 240 is coupled through a relay to the line voltage neutral line; alternatively, such a relay may be coupled in series between the line connection at 224a the corresponding electrode 240. A second coil 232 is wound around a second portion of the central cylinder of core 236 with a first end of the winding coupled to load-side fixed contact 224b and a second side of the winding coupled to load-side terminal connector 208b.

When the first coil 230 (also referred to herein as an independent coil) is energized, movable core 238 moves within stationary core 236 against the bias of spring 234 to close contacts 224. With the contacts 224 closed, current at a first current level may flow through OPC 210, through the second coil 232 which is series connected with the OPC 210 and contacts 224, and on to the load(s) drawing power from, for example, a load center bus (not shown). In an embodiment, the first current level may be equal to or less than the maximum level of current which can safely flow through contacts 222 while closed (e.g., at a current level which does not cause damage to the contacts of contactor component 220). The first current level matches the current protective capacity of the OPC 210 and, in an embodiment, the rated load drawing capacity (e.g., 200 A) of a load center to which it is coupled.

At some point, the condition giving rise to a call for power from an alternate power source may cease, at which time coil 230 may be de-energized. The spring constant of spring 234 is such, however, that the contacts 224 do not open for so long as the current flowing through the still-closed contacts 224 is beyond a second current level. In an embodiment, the second current level corresponds to a level at which the contacts 224 may open and close (also referred to as “make” or “break”) without causing an arcing condition sufficient to damage the contacts of contactor component 220.

In embodiments, the second current level is substantially lower than the first current level. This asymmetry in continuous vs. make/break rating required of the contacts can be exploited to fabricate contactors having substantially reduced cost as compared to a contactor having the same rating for continuous flow and making/breaking the flow of current. Contacts designed, for example, to have a make/break capability of 50 A or below, as might be sufficient to power a microgrid for extended periods, are expected to require substantially less material and/or physical space than those designed for 200 A. Should it become necessary or desirable to disconnect an associated load center or a load from conductor 202 while the power exceeds the second current level, the manual disconnect associated with OPC 210 may be utilized or, in embodiments, OPC 210 may optionally include a conventional shunt trip coil (not shown) to permit remote (i.e., non-manual) operation based on application of an appropriate control input.

FIG. 3 is a block diagram of a split phase microgrid interconnect device (MID) 300 in accordance with one or more embodiments of the present invention. The MID 300 is one embodiment of the MID 140. In an embodiment, MID 300 is a multiphase (e.g., a double pole, 240V AC) implementation receiving alternating current (AC) power over a pair of conductors 302 and 304 respectively coupled to line connector terminals 308-1a and 308-2a, respectively. Although the conductors 302 and 304 are shown carrying phases A and B as may be supplied by a power distribution grid and/or microgrid 150 in a conventional 240V AC residential installation, it should be understood that such depiction is for exemplary purposes only and that embodiments consistent with the present disclosure may be readily adapted for three phase installations (e.g., operating at 208/120V or 480/277V). The conductors 302 and 304 are coupled to a normally open, overcurrent protection component (OPC) 310 of MID 300. The OPC 310 may, like the OPC 210 of the single phase embodiment depicted in FIG. 2, have the construction of a fused switch or of a circuit breaker (as shown) such that it is capable of being manually opened or closed, as well as opened in the event of an overcurrent or fault condition.

Once closed, OPC 310 may supply power to a set of normally open contacts 322 and 324 which, when closed, are in contact with corresponding fixed contacts 322a/322b and 324a/324b (although in some alternative embodiments the normally open contacts 322 and 324 may be normally closed) of dual coil contactor component 320. In a split phase embodiment as shown in FIG. 3, the movable part of each of contacts 322 and 324 is carried by a single movable magnetic core 338 within a stationary magnetic core 336, but these movable parts are isolated and insulated from one another by movable core extension 338a. The stationary core 336 and the movable core 338 are magnetic cores generally shaped and positioned analogous to the stationary core 236 and the movable core 238, respectively. A first end of the stationary core 336 is coupled to a circular magnetic base 390; in some embodiments, the base 390 may be part of the form factor of the stationary core 336. The movable core 338 is substantially T-shaped and having the vertical bar of the “T” disposed through the hollow center of stationary core 336 with the end of the vertical bar coupled to the first end of a spring 334 such that, when the spring 334 is in a first position (e.g., compressed), the horizontal bar of the “T” is flush with the second end of the stationary core 336 and the contacts 324 and 322 are closed. The second end of the spring 334 is coupled to the base 390 (or, alternatively, another fixed structure). A first coil 330 (also referred to as independent coil 330) is wound around a first portion of the central cylinder of the core 336 with the ends of the winding coupled to electrodes 340 for receiving a control signal. A second coil 332 is wound around a second portion of the central cylinder of the core 336 with a first end of the winding coupled to the grid-side of the set of contacts 324 and a second side of the winding coupled to a load-side terminal connector 308-2b.

When independent coil 330 is energized, movable core 338 moves within stationary core 336 against the bias of spring 334 to close contacts 322 and 324. While contacts 322 and 324 are closed, line current supplied by a power distribution grid (e.g., at or below a first current level) may flow through OPC 310 and contacts 322 and 324 to reach, via respective terminal connections 308-1b and 308-2b, the load(s) drawing power from, for example, a load center bus (not shown).

In an embodiment, the first current level may be equal to or less than the maximum level of current which can safely flow through contacts 322 and 324 while they are closed (e.g., at a current level which does not cause damage to the contacts of contactor component 320). The first current level may equal or exceed the current protective capacity of the OPC 310 and, in an embodiment, the rated load drawing capacity (e.g., 200 A) of a load center to which it is coupled.

In the split phase embodiment connected as shown in FIG. 3, normally open contact 324 is shown as being dimensioned and arranged to make and break a series connection between OPC 310 and a second coil 332. Being likewise connected to movable core 338 by extension 338a, current flow through contacts 322 is also made or broken at the same time as current flow through contacts 324. While the coil 332 is shown as being series-connected to phase B via contact 324, it should be borne in mind that such a connection is depicted by way of example only. By way of alternative example, coil 332 may be series-connected instead to phase A (e.g., by switching the appropriate line and load connections at terminals 308 or by utilizing a mirror image of the configuration of the embodiment shown in FIG. 3 and wiring them in the order shown).

By way of further alternative, rather than a split phase configuration, embodiments consistent with the present disclosure might utilize, for each phase, a separate dual coil contactor structure similar to that shown in FIG. 2. In some such alternate embodiments, two or three independent coils as coil 230 of FIG. 2 may be coupled together in series and tied to a single control input or, in other embodiments, the independent coils may be kept separate and coupled to respective contacts of a control relay. A mechanical interlock tying the contacts together may be used to implement simultaneous making or breaking of all phases when closure of any one of them is triggered.

Returning to FIG. 3, when the condition(s) giving rise to a call for power from an alternate power source ceases, coil 330 may be de-energized. The spring constant of spring 334 is such, however, that the contacts 322 and 324 do not open for so long as the current flowing through the second coil 332 (i.e. through the set of contacts 324) is beyond a second current level. In an embodiment, the second current level corresponds to a level at which the contacts 322 and 324 may open and close without causing an arcing condition sufficient to damage the contacts of contactor component 320. As noted previously, the second current level may be substantially lower than the first current level to facilitate fabrication of contactors having substantially reduced cost as compared to a contactor having the same rating for continuous flow and making/breaking the flow of current. Here again, should it become necessary or desirable to disconnect MID 300 from conductors 302 and 304 when the power exceeds the second current level, the manual disconnect associated with OPC 310 may be utilized or, if included, a shunt trip coil integral with a circuit breaker implementation of OPC 310 may be energized to remotely and/or automatically initiate a disconnection of a load and/or load center.

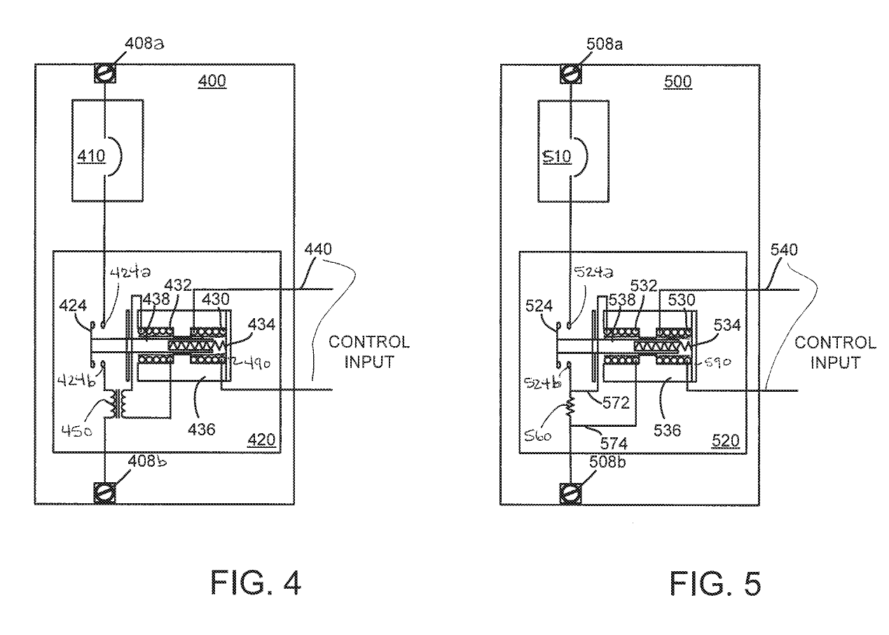

FIG. 4 is a block diagram of a microgrid interconnect device 400 utilizing a transformer approach to energization of a line power receiving coil 432 in accordance with one or more embodiments of the present invention. The MID 400 is one embodiment of the MID 140. The embodiment of FIG. 4 includes an OPC 410, coupled between a fixed contact 424a and a grid-side terminal connector 408a, as well as a contactor component 420 which includes a transformer 450, stationary core 436, movable core 438, independent coil 430 (also referred to as first coil 430), and line power receiving coil 432 (also referred to as second coil 432). The stationary core 436 and the movable core 438 are magnetic cores generally shaped and positioned analogous to the stationary core 236 and the movable core 238, respectively. A first end of the stationary core 436 is coupled to a circular magnetic base 490; in some embodiments, the base 490 may be part of the form factor of the stationary core 436. The movable core 438 is substantially T-shaped and having the vertical bar of the “T” disposed through the hollow center of stationary core 436 with the end of the vertical bar coupled to the first end of a spring 434 such that, when the spring is in a first position (e.g., compressed), the horizontal bar of the “T” is flush with the second end of the stationary core 436 and the contacts 424 are closed. The second end of the spring 434 is coupled to the base 490 (or, alternatively, another fixed structure). First coil 430 is wound around a first portion of the central cylinder of the core 436 with the ends of the winding coupled to electrodes 440 for receiving a control signal. Second coil 432 is wound around a second portion of the central cylinder of the core 436 with the ends of the winding coupled across the secondary winding of the transformer 450. The primary winding of the transformer 450 is coupled between a fixed contact 424b and a load-side terminal connector 408a.

The spring 434 biases the movable core 438 into a position in which movable contacts 424 remain in the open position shown (i.e., not contacting fixed contacts 424a and 424b) until application of a control input to the first coil 430. In an embodiment, upon application of a control input via electrodes 440, movable core 438 is urged into a position which closes contacts 424 (i.e., the movable contacts 424 are in contact with the fixed contacts 424a and 424b). Once the contacts 424 are closed, OPC 410 may be operated to enable flow of line current through the primary coil of transformer 450, which induces a current in the transformer's secondary winding and through second coil 432. Line and load connections are made via terminals 408a and 408b, respectively.

With an appropriate turns ratio selected for transformer 450, the current induced in the secondary coil of transformer 450 is sufficient to maintain the contacts 424 in the closed position for so long as the induced current through the second coil 432 is above the make and break rating of the contacts 424. Even after de-energization of independent coil 430 has already occurred, the force of spring 434 is insufficient to bias the movable core 438 and contacts 424 into the break (i.e., open) position until the point at which the current flow induced in the secondary coil of transformer 450 and through the second coil 432 is no longer sufficient to overcome that biasing force (i.e., when the current level through the second coil 432 falls below the second current level). Prior to that point, current flow through MID 400 can be interrupted by manual operation of the OPC 410 disconnect or, in embodiments where OPC 410 is implemented a circuit breaker with a shunt trip coil, the MID 400 may be disconnected by energization of a shunt trip coil.

FIG. 5 is a block diagram of a microgrid interconnect device 500 utilizing a current divider approach to energization of a line power receiving coil 532 in accordance with one or more embodiments of the present invention. The MID 500 is one embodiment of the MID 140. The embodiment of FIG. 5 includes an OPC 510, coupled between a fixed contact 524a and a grid-side terminal connector 508a, as well as a contactor component 520 which includes a resistance 560, stationary core 536, movable core 538, independent coil 530 (also referred to as first coil 530), and line power receiving coil 532 (also referred to as second coil 532). The stationary core 536 and the movable core 538 are magnetic cores generally shaped and positioned analogous to the stationary core 236 and the movable core 238, respectively. A first end of the stationary core 536 is coupled to a circular magnetic base 590; in some embodiments, the base 590 may be part of the form factor of the stationary core 536. The movable core 538 is substantially T-shaped and having the vertical bar of the “T” disposed through the hollow center of stationary core 536 with the end of the vertical bar coupled to the first end of a spring 534 such that, when the spring is in a first position (e.g., compressed), the horizontal bar of the “T” is flush with the second end of the stationary core 536 and the contacts 524 are closed. The second end of the spring 534 is coupled to the base 590 (or, alternatively, another fixed structure). First coil 530 is wound around a first portion of the central cylinder of the core 536 with the ends of the winding coupled to electrodes 540 for receiving a control signal. Second coil 532 is wound around a second portion of the central cylinder of the core 536 with the ends of the winding coupled across the resistance 560, where the resistance 560 is coupled between fixed contact 524b and load-side terminal connector 508b.

The spring 534 biases the movable core 538 into a position which keeps normally open contacts 524 open (i.e., not contacting fixed contacts 524a and 524b). Upon application of a control input via electrodes 540, the coil 530 is energized such that movable core 538 is urged into a closed position which closes contacts 524 (i.e., movable contacts 524 are moved to be in contact with the fixed contacts 524a and 524b). Once the contacts 524 are closed, OPC 510 may be operated to enable flow of line current through the resistance 560. Line and load connections of MID 500 are made via line and load terminals 508a and 508b, respectively.

The resistance 560 may be a resistor coupled across the feed and return connectors 572 and 574 coupled to line power receiving coil 532 and interconnecting the fixed load contact 524b of contactor component 520 and load terminal 508b. Although a discrete resistor is shown coupled across the terminals of coil 532, such a component may be omitted in some embodiment, depending upon the selection of materials used in making the various interconnections (i.e., the electrical resistance of the wire used across the terminals of coil 532 may be sufficient for implement of a current divider consistent with embodiments of the present disclosure.

In operation, contacts 524 are closed (e.g., by delivery of a control input at electrodes 540) and then OPC 510 is operated (i.e., closed), enabling current to flow through contacts 524 to load terminal 508b and also across coil 532. The latter flow causes contacts 524 to remain in the closed position for as long as the coil 530 remains energized and the current flowing through the coil 532 is above the second current level, e.g., the make and break rating of the contacts 524 or some threshold lower than that determined by the spring constant of spring 534 and the number of turns in coil 532. It suffices to say that provided the independent coil 530 has been de-energized (or shunt trip operation of OPC 510 has occurred), spring 534 biases the movable core 538 (and set of contacts 524) into the open position once the current flowing through coil 532 falls below the second current level, at which point the current is too low to overcome the biasing force exerted by spring 534.

While the foregoing is directed to embodiments of the present invention, other and further embodiments of the invention may be devised without departing from the basic scope thereof, and the scope thereof is defined by the claims that follow.

1. An apparatus for electrically coupling a microgrid to and from a power distribution grid, comprising:
an interconnect device, coupled to the microgrid and the power distribution grid, comprising:
an overcurrent protection component (OPC) for interrupting a circuit during an overcurrent condition; and
a contactor component, coupled in series with the OPC and independently operable from the OPC, comprising:
a set of contacts movable between a first position and a second position;
a first coil energizable to move the set of contacts from the first position into the second position; and
a second coil energizable, independently of the first coil, to maintain the contacts in the second position after the first coil is de-energized until a level of current flowing through the set of contacts is less than a lower current level.

2. The apparatus of claim 1, wherein the contactor component has a continuous amp rating on the order of a continuous amp rating of the OPC, and wherein the contactor component has a make/break amp rating substantially less than a make/break amp rating of the OPC.

3. The apparatus of claim 2, wherein the lower current level is less than or equal to the make/break amp rating of the contactor component.

4. The apparatus of claim 1, wherein the contactor component further comprises:
a stationary core;
a movable core, disposed within the stationary core and coupled to the set of contacts; and
a spring coupled to the movable core; wherein, when the first coil is energized to move the set of contacts from the first position into the second position, the movable core moves within the stationary core against the bias of the spring to move the set of contacts into the second position.

5. The apparatus of claim 4, wherein when the set of contacts are in the second position, the second coil is coupled in series with the set of contacts.

6. The apparatus of claim 5, wherein, after the first coil is de-energized and while the level of current flowing through the set of contacts is greater than the lower current level, the force of the spring is insufficient to move the movable core such that the set of contacts are moved to the first position until the level of current flowing through the set of contacts is less than the lower current level.

7. The apparatus of claim 4, further comprising a transformer, wherein the secondary winding is coupled across the second coil, and wherein, when the set of contacts are in the second position, the primary winding of the transformer is coupled in series with the set of contacts.

8. The apparatus of claim 4, further comprising a resistance coupled across the second coil, wherein, when the set of contacts are in the second position, a parallel combination of the resistance and the second coil is coupled in series with the set of contacts.

9. The apparatus of claim 1, wherein the first set of contacts moves from the first position to the second position for coupling a first phase of power to at least one load, and wherein the contactor component further comprises a second set of contacts movable, when the first set of contacts moves from the first position to the second position, from an open position and a closed position for coupling a second phase of power to at least one load.

10. A system for coupling power between a microgrid and a power distribution grid, comprising:
a distributed energy resource (DER) for generating power within the microgrid; and
an interconnect device, coupled to the microgrid and the power distribution grid, for electrically coupling the microgrid to and from the power distribution grid, comprising:
an overcurrent protection component (OPC) for interrupting a circuit during an overcurrent condition; and
a contactor component, coupled in series with the OPC and independently operable from the OPC, comprising:
a set of contacts movable between a first position and a second position;
a first coil energizable to move the set of contacts from the first position into the second position; and
a second coil energizable, independently of the first coil, to maintain the contacts in the second position after the first coil is de-energized until a level of current flowing through the set of contacts is less than a lower current level.

11. The system of claim 10, wherein the contactor component has a continuous amp rating on the order of a continuous amp rating of the OPC, and wherein the contactor component has a make/break amp rating substantially less than a make/break amp rating of the OPC.

12. The system of claim 2, wherein the lower current level is less than or equal to the make/break amp rating of the contactor component.

13. The system of claim 10, wherein the contactor component further comprises:
a stationary core;
a movable core, disposed within the stationary core and coupled to the set of contacts; and
a spring coupled to the movable core; wherein, when the first coil is energized to move the set of contacts from the first position into the second position, the movable core moves within the stationary core against the bias of the spring to move the set of contacts into the second position.

14. The system of claim 13, wherein when the set of contacts are in the second position, the second coil is coupled in series with the set of contacts.

15. The system of claim 14, wherein, after the first coil is de-energized and while the level of current flowing through the set of contacts is greater than the lower current level, the force of the spring is insufficient to move the movable core such that the set of contacts are moved to the first position until the level of current flowing through the set of contacts is less than the lower current level.

16. The system of claim 13, further comprising a transformer, wherein the secondary winding is coupled across the second coil, and wherein, when the set of contacts are in the second position, the primary winding of the transformer is coupled in series with the set of contacts.

17. The system of claim 13, further comprising a resistance coupled across the second coil, wherein, when the set of contacts are in the second position, a parallel combination of the resistance and the second coil is coupled in series with the set of contacts.

18. The system of claim 10, wherein the first set of contacts moves from the first position to the second position for coupling a first phase of power to at least one load, and wherein the contactor component further comprises a second set of contacts movable, when the first set of contacts moves from the first position to the second position, from an open position and a closed position for coupling a second phase of power to at least one load.

19. The system of claim 10, wherein the DER comprises a plurality of DC-AC inverters coupled to a plurality of DC power sources in a one-to-one correspondence.

20. The system of claim 19, wherein the DC power sources are photovoltaic (PV) modules.
